(19) United States
(12) Patent Application Publication
(10) Pub. No.: US 2009/0198813 A1
(43) Pub. Date: Aug. 6, 2009

(54) SERVER APPARATUS AND COMPUTER READABLE RECORDING MEDIUM

(75) Inventors: Ayako Yoshimura, Tokyo (JP); Mitsuyoshi Yamatari, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/187,628

(22) Filed: Aug. 7, 2008

(30) Foreign Application Priority Data
Feb. 5, 2008 (JP) 2008-025298

(51) Int. Cl. G06F 15/173; G06F 9/30

(52) U.S. Cl. 709/224; 712/225; 712/E09.016

(57) ABSTRACT

Prior to a request from an integrated system 131, a browser engine pool managing section 104 makes browser engines correspond to the respective types of data processing of an existing system 141 and acquire predetermined standby screens, and then puts the browser engines on standby in that state, upon receipt of the request from the integrated system 131, the browser engine pool managing section 104 makes a browser engine corresponding to requested data processing perform an operation subsequent to an operation using a standby screen, and instruct the existing system 141 to execute the data processing requested from the integrated system 131.

### BACKGROUND OF THE INVENTION

1. Field of the Invention

The present invention relates to a server apparatus that instructs a data processing system to perform data processing in response to a request from a client device.

More particularly, the present invention relates to a management technique of emulated images in a wrapping engine apparatus that is operable to emulate the operation of an existing system and reuse existing functions.

2. Description of the Related Art

A wrapping system has been provided to emulate the terminal of a legacy system such as a mainframe and offer the functions thereof to a client device.

The wrapping system, upon request for data processing in a legacy system from a client device, emulates the operation of a terminal used for the legacy system, instructs the legacy system to perform the data processing, and then transmits a processing result to the client device.

The terminal emulation by the wrapping system makes the legacy system determine that the data processing has been instructed from the terminal.

Among wrapping systems such as that described above, JP 2004-302725 A discloses a “legacy wrapping system and a processing method in legacy wrapping system” describing a management technique of a terminal to be emulated.

According to JP 2004-302725 A, two or more terminal emulation programs are provided for wrapping and connecting a client to a mainframe. Then, a terminal emulation program that is capable of executing a request from the client for the shortest period of time is selected for processing based on screen transition time, transmission time, processing time, etc. measured in advance for the respective terminal emulation programs. This allows efficient processing.

With the technique described in JP 2004-302725 A, an object is to provide an emulation environment for efficient emulation. In response to a request from a client device, an emulation environment allowing a shift to a target screen in the shortest period of time is selected from among emulation environments managed, based only on the condition of processing time, such as screen transition time for the respective screens and transmission time.

The art of JP 2004-302725 A therefore poses a disadvantage that no consideration is given to the business activity to which a request from a client relates, overall access conditions, and the like.

Another disadvantage is that no optimization is given to emulation environments managed, prior to the arrival of a request from a client.

[Patent Document 1] JP 2004-302725 A

### SUMMARY OF THE INVENTION

One of the objects of the present invention is to solve disadvantages such as those described above. The objects of the present invention include: to provide an optimal emulation screen in consideration of business activities; and to achieve emulation efficiency by optimization performed in a server for emulation prior to the arrival of a request from a client device.

These and other objects of the embodiments of the present invention are accomplished by the present invention as hereinafter described in further detail.

According to one aspect of the present invention, a server apparatus may be connected to a data processing system performing data processing. The server apparatus may includes: an execution instructing section that may instruct the data processing system to perform the data processing; a standby operation information memory section that may store standby operation information indicating a specific operation, as a standby operation, among a set of operations needed for the execution instructing section instructing the data processing system to perform the data processing; a preliminary procedure information memory section that may store preliminary procedure information indicating an operating procedure until the standby operation; and an operation managing section that may set the execution instructing section to a state where the standby operation has been executed, based on the standby operation information and the preliminary procedure information, and put the execution instructing section on standby in the state where the standby operation has been executed.

According to another aspect of the present invention, a computer readable recording medium encoded with computer program instructions, which when executed by a computer having a storage device and an execution instructing section that may instruct a data processing system for performing data processing to execute the data processing, cause the computer to carry out a method of managing the execution instructing section. The method may include: acquiring, from the storage device, standby operation information indicating a specific operation, as a standby operation, among a set of operations needed for the execution instructing section instructing the data processing system to execute the data processing; acquiring, from the storage device, preliminary procedure information indicating an operating procedure until the standby operation; setting the execution instructing section to a state where the standby operation has been executed, based on the standby operation information and the preliminary procedure information so that the execution instructing section is set; and putting the execution instructing section on standby in the state where the standby operation has been executed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a system configuration example of a wrapping system according to a first embodiment;

FIG. 2 shows a flow chart illustrating an operation example of a wrapping engine apparatus according to the first embodiment;

FIG. 3 shows a script example according to the first embodiment;

FIG. 4 shows an example of pooling information according to the first embodiment;

FIG. 5 shows an example of standby screen information according to the first embodiment;

FIG. 6 shows an example of browser engine information according to the first embodiment;

FIG. 7 shows an example of script/standby screen correspondence information according to the first embodiment;

FIG. 8 shows an example of screen transition information according to the first embodiment;

FIG. 9 shows a system configuration example of a wrapping system according to a second embodiment;

FIG. 10 shows an example of script/standby screen correspondence information according to the second embodiment;

FIG. 11 shows a flow chart illustrating an operation example of a wrapping engine apparatus according to the second embodiment;

FIG. 12 shows an example of standby screen information according to a third embodiment;

FIG. 13 shows a flow chart illustrating an operation example of a wrapping engine apparatus according to the third embodiment;

FIG. 14 shows a system configuration of a wrapping system according to a fourth embodiment;

FIG. 15 shows an example of pooling information according to the fourth embodiment;

FIG. 16 shows an example of script/standby screen correspondence information according to the fourth embodiment;

FIG. 17 shows a flow chart illustrating an operation example of a wrapping engine apparatus according to the fourth embodiment;

FIG. 18 shows an example of standby screen information according to the first embodiment;

FIG. 19 shows an example of standby screen information according to the first embodiment;

FIG. 20 shows a flow chart illustrating an operation example of a wrapping engine apparatus according to the first embodiment; and

FIG. 21 shows a hardware configuration example of the wrapping engine apparatus according to the first to fourth embodiments.

### DETAILED DESCRIPTION OF THE INVENTION

Reference will now be made in detail to the present preferred embodiments of the invention, examples of which are illustrated in the accompanying drawings, wherein like reference numerals indicate like devices through out the several views.

### Embodiment 1

Embodiments of the present invention will be discussed below with reference to the accompanying drawings.

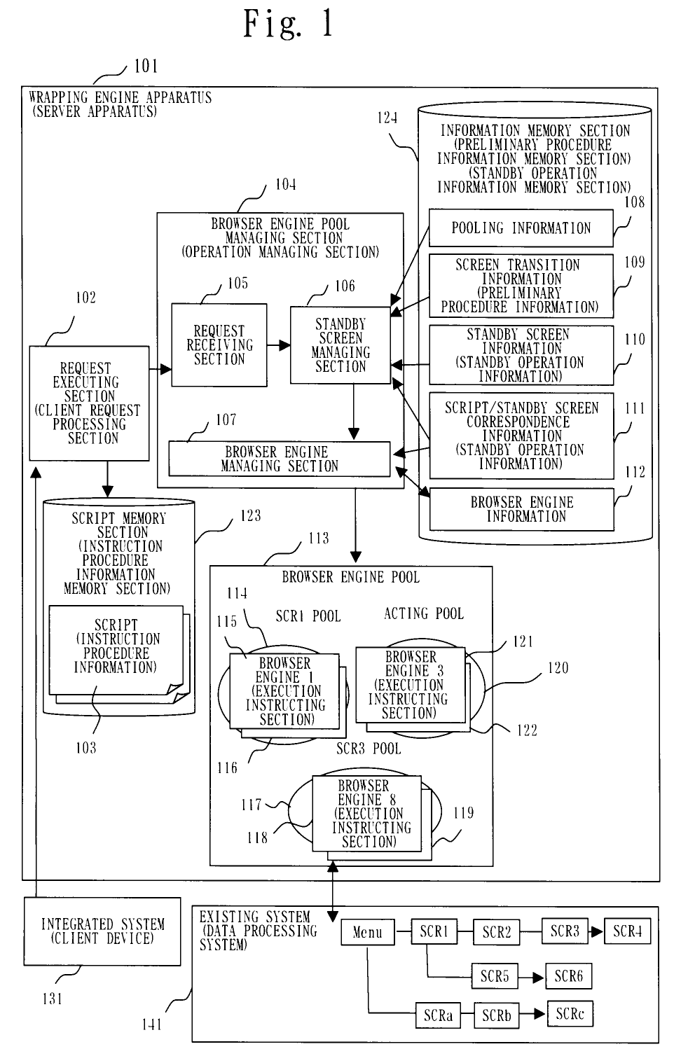

FIG. 1 shows a system configuration example of a wrapping system according to a first embodiment.

Referring to FIG. 1, a wrapping engine apparatus 101 is connected to an integrated system 131 as a client device and an existing system 141 as a legacy system.

The wrapping engine apparatus 101 receives a request from the integrated system 131 and then instructs the existing system 141 to perform data processing by terminal emulation.

The wrapping engine apparatus 101 is an example of a server apparatus.

The existing system 141 is an example of a data processing system.

It is assumed in this embodiment that the existing system 141 is operable to perform two or more types of data processing in response to an instruction from the wrapping engine apparatus 101.

Menu, SCR (screen) 1, etc. in the existing system 141 indicate screens to be used when the existing system 141 receives an instruction for data processing.

The wrapping engine apparatus 101 needs to instruct a type of data processing by performing a screen transition specified to each type of data processing through terminal emulation.

The wrapping engine apparatus 101 includes a request executing section 102, a browser engine pool managing section 104, a browser engine pool 113, a script memory section 123, and an information memory section 124.

The request executing section 102 receives a request for data processing from the integrated system 131 and instructs the browser engine pool managing section 104 to execute a script 103 defining emulation information.

The request executing section 102 is a example of a client request processing section.

The script memory section 123 stores two or more of the scripts 103.

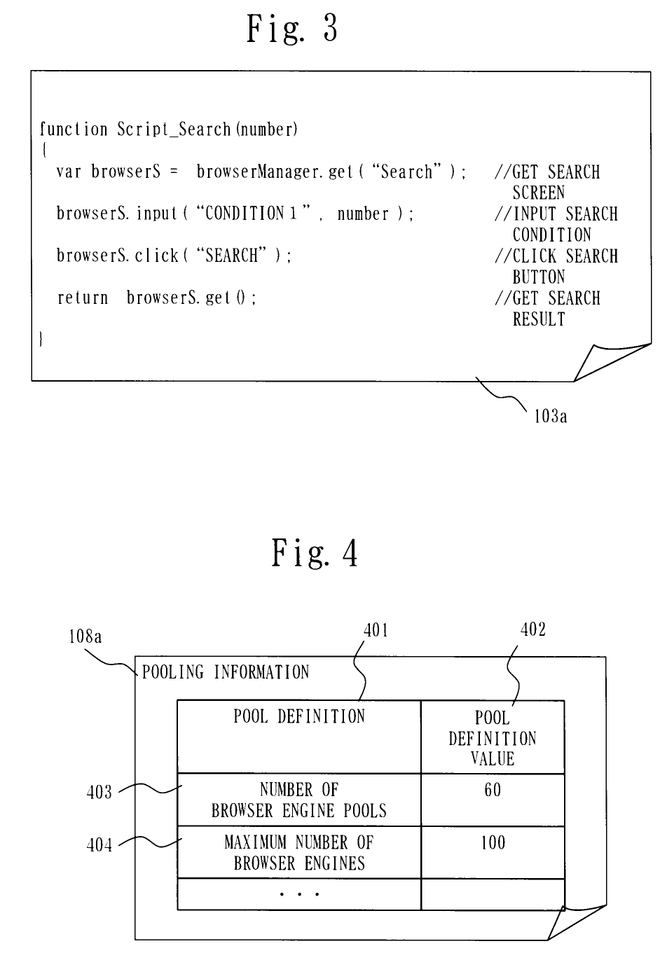

Browser engines managed in the browser engine pool 113 are put on standby in a state where a predetermined standby operation has been performed, which will be described later in detail. The script 103, as shown in FIG. 3, may indicate the procedure of an operation subsequent to the standby operation, for example. Note that the standby operation is one (a mid-operation) of a series of operations needed before instructing the existing system 141 to execute each data processing.

The script memory section 123 may include two or more of the scripts 103. The scripts 103 correspond to the respective types of data processing to be executed by the existing system 141.

The script 103 is an example of instruction procedure information. The script memory section 123 is an example of an instruction procedure information memory section.

The browser engine pool 113 may include two or more of the browser engines to be used for emulating the existing system 141, managed therein.

The browser engines may be grouped and managed in the browser engine pool 113.

The browser engine may instruct the existing system 141 to execute data processing requested from the integrated system 131.

The browser engine is an example of an execution instructing section.

The browser engine pool managing section 104 manages browser engines in the browser engine pool 113.

More specifically, the browser engine managing section 104 assigns at least one of the browser engines to each data processing performed by the existing system 141, based on screen transition information 109, standby screen information 110, script/standby screen correspondence information 111 stored in the information memory section 124. The browser engine managing section 104 sets each of the browser engines to a state where operations up to the standby operation have been executed, and puts the browser engine on standby in the state where the operations up to the standby operation have been executed.

The browser engine pool managing section 104 of this embodiment makes each browser engine perform a set of operations until the operation (the standby operation) to acquire a given screen (a standby screen), and keeps the browser engine on standby in a state where the browser engine has acquired the standby screen.

The browser engine pool managing section 104, upon receipt of a request of the integrated system 131 at the request executing section 102, makes a standby browser engine execute an operation subsequent to the standby operation based on the script 103 and instruct the existing system 141 to execute data processing.

The browser engine pool managing section 104 is an example of an operation managing section.

The information memory section 124 stores a variety of information (pooling information 108, the screen transition information 109, the standby screen information 110, the script/standby screen correspondence information 111, and browser engine information 122) to be used by the browser engine pool managing section 104.

The information memory section 124 is an example of a preliminary procedure information memory section and a standby operation information memory section.

The pooling information 108, an example of which is shown in FIG. 4, may relate to the browser engines that are pooled in the browser engine pool 113. More specifically, the pooling information 108 may indicate the number of different pools of the browser engines, a maximum number of different pools of the browser engines, and the like in the browser engine pool 113.

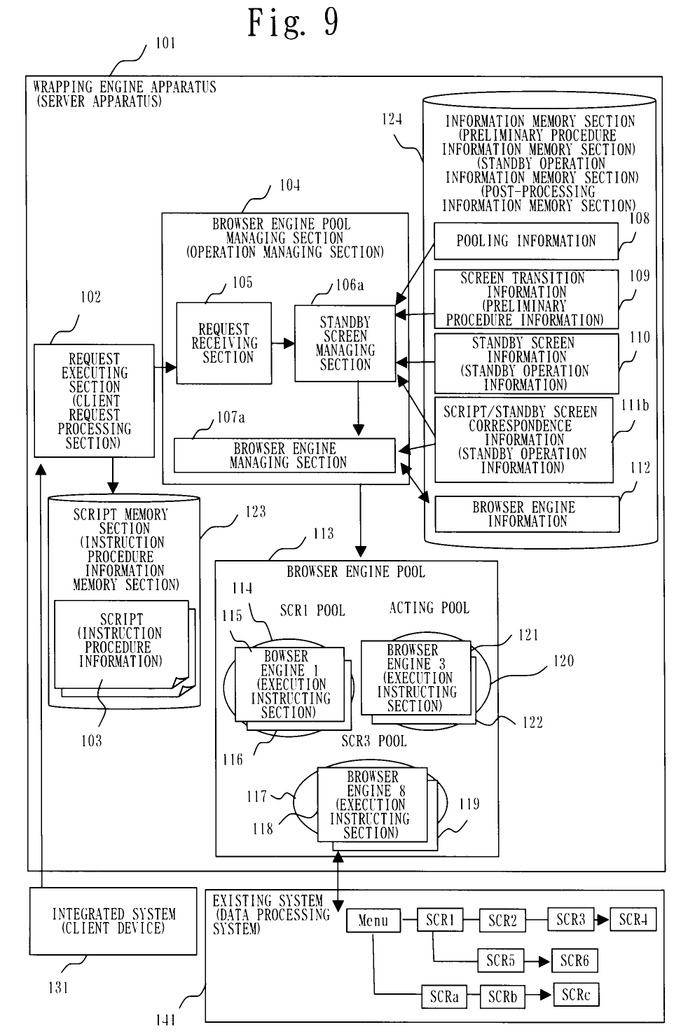

The screen transition information 109, an example of which is shown in FIG. 8, indicates an operating procedure up to the standby operation (an operation for acquiring the standby screen).

The screen transition information 109 is an example of preliminary procedure information.

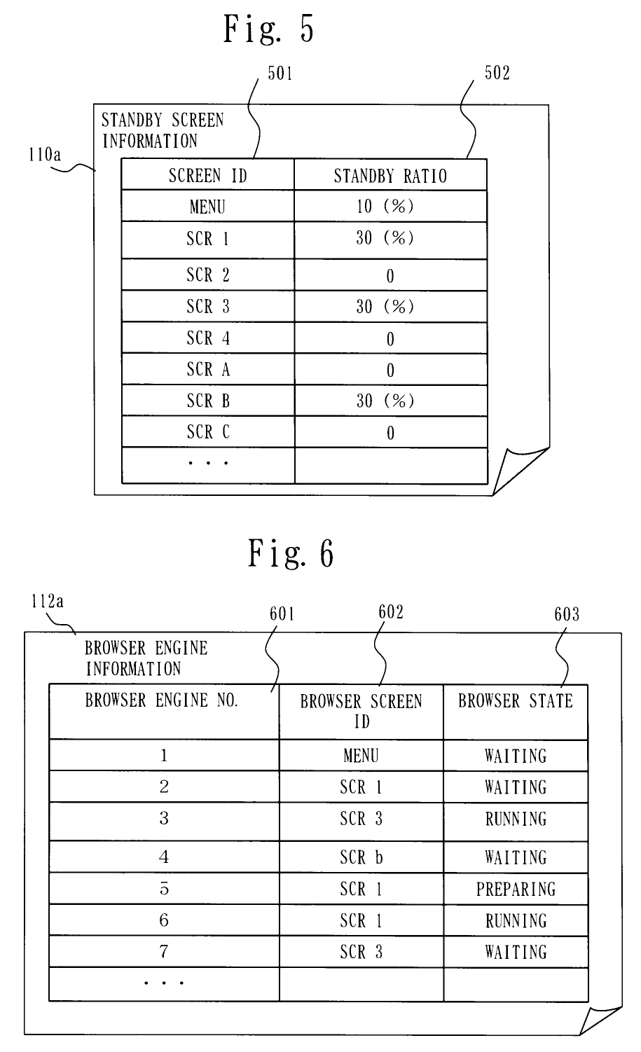

The standby screen information 110, an example of which is shown in FIG. 5, specifies the ratio (or number) of browser engines to be put on standby for each standby screen.

An operation for acquiring the standby screen specified by the standby screen information 110 is the standby operation.

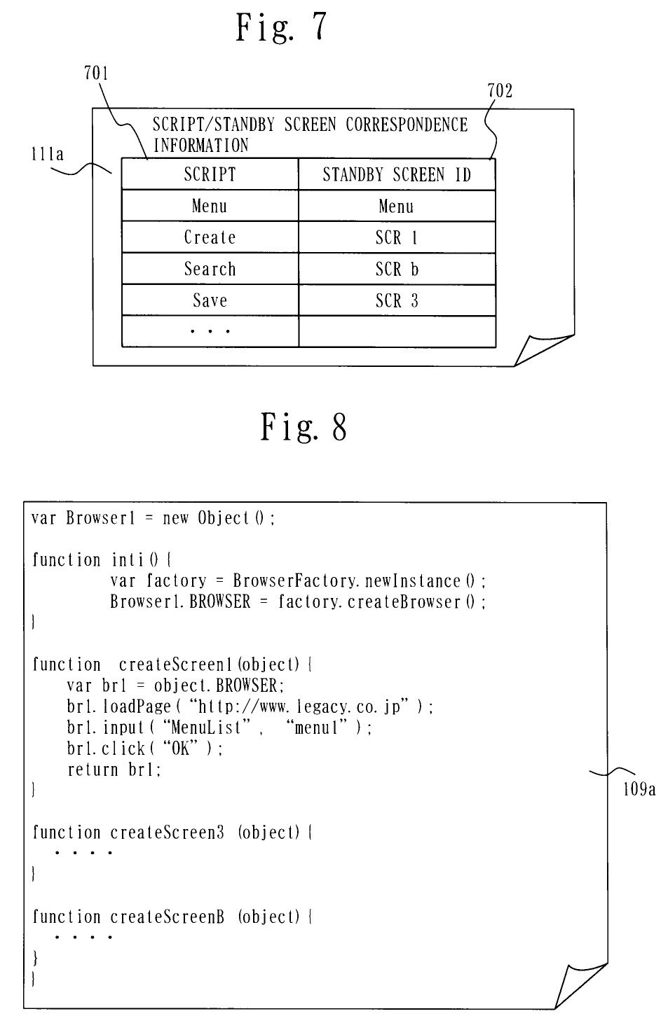

The script/standby screen correspondence information 111, an example of which is shown in FIG. 7, indicates correspondence between the script 103 and the standby screen. Each of the scripts 103 is associated with each data processing (processing of Menu, Create, Search, Save, or the like) to be executed by the existing system 141. Therefore, the script/standby screen correspondence information 111 indicates the standby screen (the standby operation) for each data processing.

The standby screen information 110 and the script/standby screen correspondence information 111 are examples of standby operation information.

The browser engine information 112, an example of which is shown in FIG. 6, indicates the state of each browser engine.

The browser engine pool managing section 104 may be configured to include a request receiving section 105, a standby screen managing section 106 and a browser engine managing section 107, and manage the state of the browser engine pool 113.

Two or more of browser engines may be assigned to each state and managed in the browser engine pool 113.

More specifically, browser engines in execution may be managed in an acting pool 120, and those not in executions, being put on standby with the same screens, may be managed in other pools, e.g., a SCR1 pool 114 and a SCR3 pool 117.

The state of the browser engine pool 113 may be managed as follows: an initial state of the operating procedure up to the standby operation is acquired by the standby screen managing section 106 based on the pooling information 108, the screen transition information 109, and the standby screen information 110. Each browser engine is then initialized by the browser engine managing section 107. The state of each browser engine pool 113 is thereafter described in the browser engine information 112.

Upon receipt of a request from the integrated system 131 as a client, the standby screen managing section 106 may acquire the ID of a standby screen corresponding to the request, by referring to the script/standby screen correspondence information 111. Then, the browser engine managing section 107 may execute an operation by using the browser engine corresponding to the screen ID.

FIG. 3 shows a script 103a as an example of the script 103.

The script 103a specifies an input of a value to the existing system 141, a button operation, and an acquisition of data after a shift to a resultant screen.

As mentioned earlier, the script 103a indicates the operating procedure subsequent to the standby operation of acquiring the standby screen.

FIG. 4 shows pooling information 108a as an example of the pooling information 108 including the items of pool definition 401 and pool definition value 402.

The pool definition 401 lists the names of definition items for the browser engine pool 113.

The pool definition value 402 lists defined values corresponding to the respected items of the pool definition 401.

More specifically, in FIG. 4, the number of browser engine pools to be managed in the browser engine pool 113 is specified as the number of browser engine pools 403, and a maximum number of browser engines in the wrapping engine apparatus 101 is specified as a maximum number of browser engines 404.

FIG. 5 shows standby screen information 110a as an example of the standby screen information 110.

The standby screen information 110a specifies a standby screen ID 501 and a standby ratio 502 in percentage (%) of the number of browser engines on standby to the total number of browser engines in the browser engine pool 113.

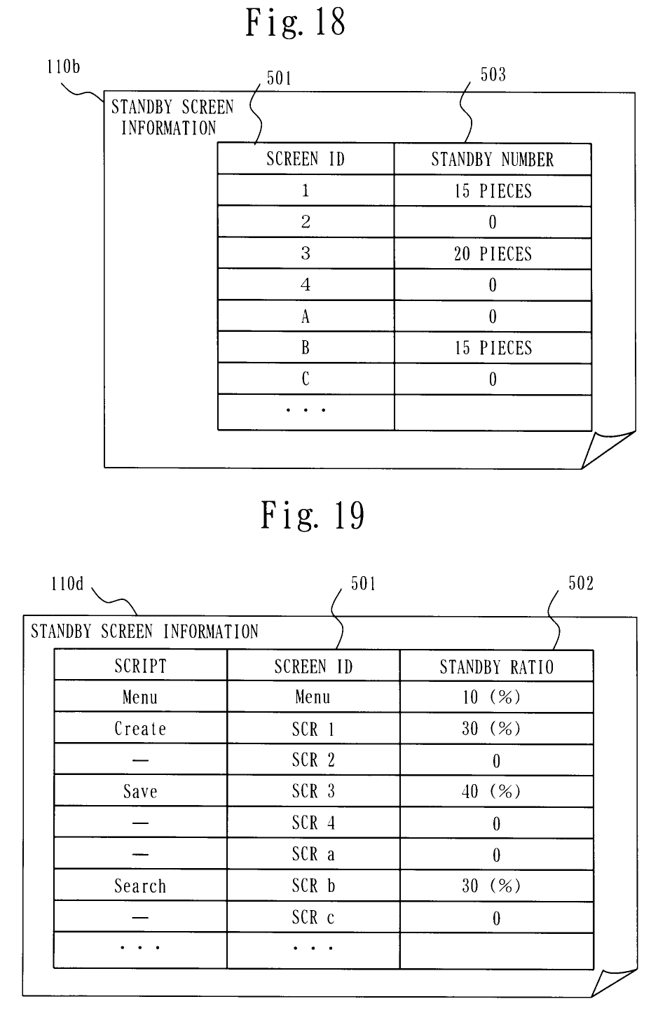

Alternatively, FIG. 18 shows standby screen information 110b including an item of standby number 503. It is also possible to thus specify the number of screens (browser engines) to be put on standby for each standby screen ID 501.

FIG. 6 shows browser engine information 112a as an example of the browser engine information 112.

An item of browser engine No. 601 includes serial numbers. The serial numbers are used to identify browser engines whose states are managed in the browser engine pool 113.

An item of browser screen ID 602 includes the identification information of the standby screen of each browser engine.

An item of current browser status 603 includes the state of each browser engine.

“Running” in the browser status 603 indicates that a browser engine is executing terminal emulation. “Waiting” and “Preparing” indicate that a browser engine is not executing terminal emulation.

FIG. 7 shows script/standby screen correspondence information 111a as an example of the script/standby screen correspondence information 111 including the items of script 701 and standby screen ID 702.

The standby screen ID 702 indicates standby screens that enables a browser engine to perform efficient processing, avoiding unnecessary screen transitions, for the respective scripts called upon requests from the integrated system 131 as a client.

Alternatively, FIG. 19 shows standby screen information 110d that includes a combination of the standby screen information 110a of FIG. 5 and the script/standby screen correspondence information 111a of FIG. 7.

The standby screen information 110d may allow collective management of correspondence relation between a script and a standby screen, and a standby ratio for each standby screen.

FIG. 8 shows screen transition information 109a as an example of the screen transition information 109.

The screen transition information 109a indicates an operation of shifting a browser engine to a standby screen.

More specifically, the screen transition information 109a shows the Uniform Resource Locator (URL) of a first screen to be displayed, and data to be inputted and a button to be clicked after the first screen is loaded, before standby with a screen 1.

Operating into screens according to the above instructions will lead to standby with a specified screen.

Alternatively, it may also be possible to convert the pooling information 108, the screen transition information 109, the standby screen information 110, and the script/standby screen correspondence information 111 into a script format.

An operation of the wrapping engine apparatus 101 of this embodiment is now discussed in detail.

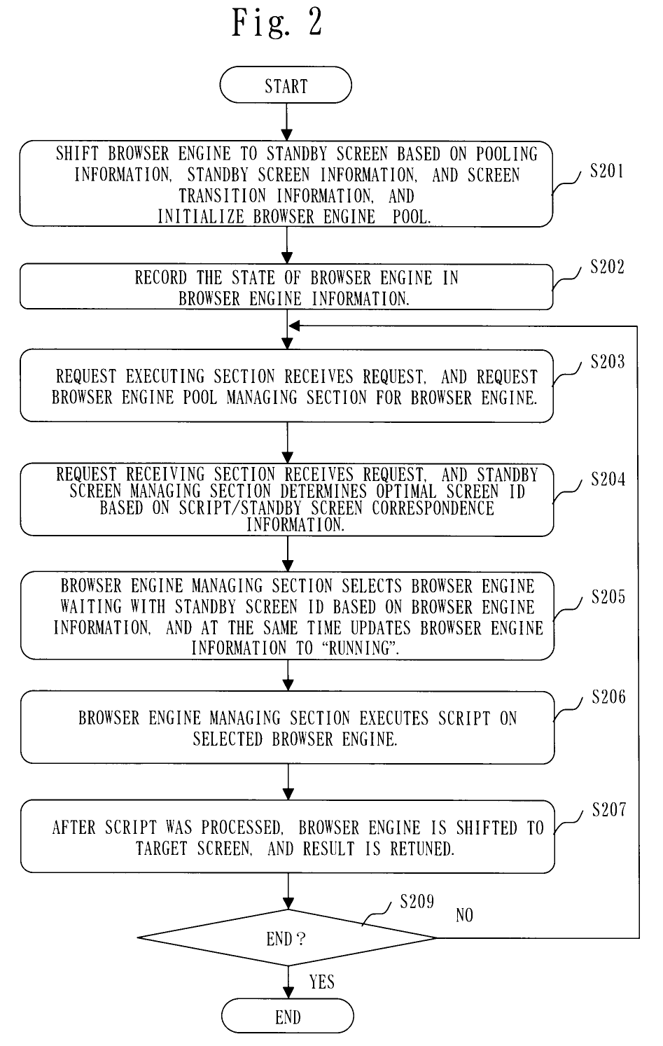

FIG. 2 shows a flow chart illustrating an operation example of the wrapping engine apparatus 101 that executes the emulation of an existing system by using an optimal browser engine according to this embodiment.

An execution example of the wrapping engine apparatus 101 is described below with reference to the flow chart of FIG. 2.

When the wrapping engine apparatus 101 is started, the standby screen managing section 106 may acquire the total number of browser engines to be pooled, by referring to the number of browser engine pools 403 specified by the pooling information 108. The standby screen managing section 106 may then determine, based on the standby screen information 110, how many screens are to be pooled for each of the specified screen IDs, with reference to information on the total number of already pooled browser engines. The browser engine managing section 107 shifts the screens of the browser engines, according to a determined value of how many screens are to be pooled, so that the browser engines are grouped and pooled.

The browser engine managing section has each browser engine move to the status corresponding to the screen ID specified respectively, based on the screen transition information 109.

More specifically, the pooling information 108a specifies 60 as the number of browser engine pools 403, and the standby screen information 110a specifies 10%, 30%, 30% and 30%, respectively, for the screens of “Menu”, “SCR1”, “SCR3”, and “SCRb” of the screen ID for browser engines pooled, for example. Therefore, “Menu”, “SCR1”, “SCR3”, and “SCRb” have six, 18, 18, and 18 screens respectively.

Then, the browser engines of the number equal to the specified number of screens are started, and pooled in the SCCR1 pool 114, the SCR3 pool 117, etc. on a screen ID basis in a sate where the standby screen has been acquired (Step S201).

When the number of browser engines is specified like the standby number 503 in the standby screen information 110b of FIG. 18, instead of the standby ratio 502 of FIG. 5, browser engines are pooled according to the number specified.

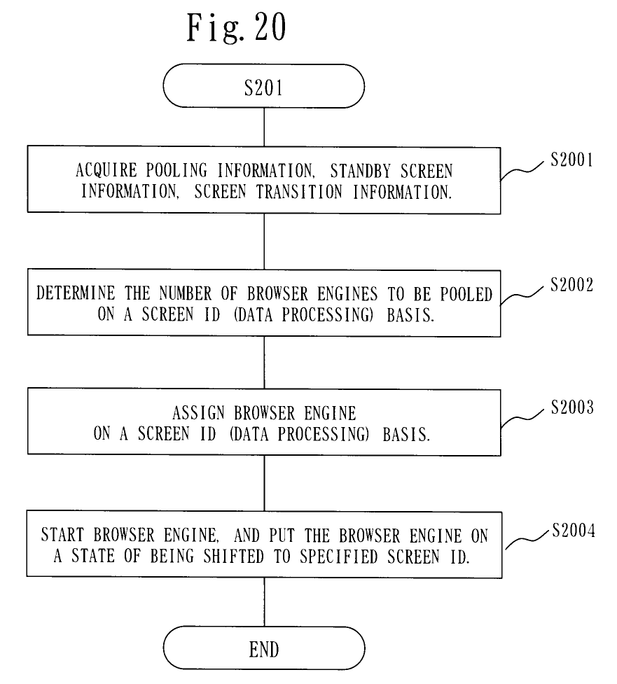

An operation performed in Step S201 is now discussed in detail with reference to FIG. 20.

When the wrapping engine apparatus 101 is started, the standby screen managing section 106 acquires the pooling information 108, the standby screen information 110, and the screen transition information 109 from the information memory section 124 (Step S2001).

Then, the standby screen managing section 106 determines the number of browser engines to be pooled on a screen ID (data processing) basis based on the pooling information 108 and the standby screen information 110 (Step S2002).

Then, the standby screen managing section 106 assigns a determined number of browser engines at Step S202 on a screen ID (data processing) basis (Step S2003).

Then, the browser engine managing section 107 starts assigned browser engines (assigned execution instructing section) on a screen ID basis, and then puts the respective browser engines in a state where the respective browser engines have been shifted to the specified screen IDs (a state where a standby screen indicated by the screen ID has been acquired) (Step S2004).

The browser engine managing section 107 instructs the respective browser engines to operate in accordance with the operating procedures indicated by the screen transition information 109, and put the respective browser engines in the state of having acquired the standby screens.

Note that whatever method may be used to acquire a standby screen by a browser engine.

For example, the screen transition information 109 may include a description of an actual operating procedure in such a way that each browser engine may communicate with the existing system 141 and then receive standby screens from the existing system 141. Then, each browser engine may communicate with the existing system 141 according to the screen transition information 109, and receive the standby screens from the existing system 141 via login processing, etc.

Alternatively, the screen transition information 109 may include a description of an operating procedure in such a way that each browser engine may obtain the substantially equal state to a state which it may have when it communicates with the existing system 141, and an operating procedure for each browser engine to generate a standby screen. Then, each browser engine may create the substantially equal state to the state which each browser engine may have when it communicates with the existing system 141, and generate the standby screen, according to the screen transition information 109, and thus obtain substantially equal state to a state where the browser engine has acquired its standby screen from the existing system 141.

Still alternatively, a representative browser engine for each screen ID may communicate with the existing system 141, and receive a standby screen. Then, a received standby screen (and other information) may be shared among other browser engines to which common screen ID is assigned.

Still alternatively, a representative browser engine for each screen ID may perform an operation similar to the operation of communicating with the existing system 141, and generate a standby screen. Then, a generated standby screen (and other information) may be shared among other browser engines to which common screen ID is assigned.

The respective browser engines, after acquiring standby screens, may be associated with the corresponding standby screens, and then put on standby.

More specifically, each browser engine is loaded in the main memory of the wrapping engine apparatus 101, in a state where the process of the browser engine is associated with a standby screen by a pointer, etc., and waiting for execution by a Central Processing Unit (CPU).

A description is now given of processing after Step S2004 of FIG. 20 as processing from Step S202 of FIG. 2.

The browser engine managing section 107 assigns numbers to all the pooled browser engines, and records the screen IDs of the standby screens of the browser engines and the browser statuses thereof in the browser engine information 112 (Step S202).

Then, when a request arrives from the integrated system 131 of a client, the request executing section 102 receives the request and selects the script 103.

The request executing section 102 requests the browser engine pool managing section 104 for a browser engine for executing the script according to the script 103 (Step S203).

The request from the integrated system 131 includes information specifying the type of the script 103 (Menu, Create, Search, Save, etc.). The request executing section 102 analyzes the request from the integrated system 131, and selects the script 103 applicable to the request.

The request executing section 102 then notifies the browser engine pool managing section 104 of the type of a selected script, and instructs an execution of the script 103 by a browser engine.

Upon instruction of an execution of the script by the request executing section 102, the request receiving section 105 receives the instruction from the request executing section 102, and the standby screen managing section 106 acquires a standby screen ID defined by the standby screen ID 702 corresponding to the specified script, based on the script/standby screen correspondence information 111, in the browser engine pool managing section 104.

More specifically, when the script of “Create” is instructed for execution by the request executing section 102, for example, the screen of “SCR1” may be determined by the standby screen managing section 106 based on the script/standby screen correspondence information 111a. When the script of “Search” is instructed for execution by the request executing section 102, then the screen of “SCRb” may be determined by the standby screen managing section 106 based on the script/standby screen correspondence information 111a (Step S204).

The browser engine managing section 107 selects a browser engine whose screen ID shown in the browser screen ID 602 corresponds to a specified standby screen ID and whose status shown in the browser status 603 is “Waiting”, with reference to the browser engine information 112a. The browser engine managing section 107 then updates the item of browser status 603 of a selected browser engine to “Running”.

More specifically, when the script of “Create” is executed, for example, the browser engine managing section 107 selects a browser engine identified by “2” of the browser engine No 601 corresponding to “SCR1” of the browser screen ID 602 and “Waiting” of the browser status 603 according to the browser engine information 112a. The browser engine managing section 107 then updates the browser status 603 to “Running” (Step S205).

Next, the browser engine managing section 107 instructs the selected browser engine to execute the script 103 (Step S206).

More specifically, the browser engine managing section 107 acquires from the script memory section 123 the script 103 corresponding to the data processing requested from the integrated system 131, and supplies the script 103 to the selected browser engine.

Alternatively, it is also possible to also receive the script 103 from the request executing section 102 when instructing the selection of the browser engine (Step S203).

When the script 103 is executed by the specified browser engine, the browser engine is shifted to a target screen. More specially, the browser engine acquires the target screen (the screen for instructing the existing system 141 to perform data processing) directly linked to the data processing requested from the integrated system 131, by executing the script 103.

Then, the browser engine acquires an output from the target screen returns the output to the script. Then, a response is returned to the integrated system 131 from the request executing section 102 (Step S207).

The process is repeated thereafter from Step S202, upon request, and the process ends with no request made (Step S209).

As aforementioned, according to this embodiment, the browser engine pool may manage the browser engine for executing the script in association with the script, in the state where the browser engine has been shifted to the standby screen, prior to a request from a client. This may result in achieving an efficiently operating wrapping engine for an existing system requiring less wait time by avoiding unnecessary screen transition.

Further, according to this embodiment, the setting of standby screen information may be updated. This may result in adjusting the number and ratio of the browser engines to be put on standby in each standby screen.

When a large number of requests for specific data processing are anticipated based on the business activities of the integrated system as a client, the browser engines assigned to such specific data processing may be increased compared to those assigned to other data processing.

When a change in trend of access from the integrated system causes a reduction in the number of requests for data processing A and an increase in the number of requests for data processing B, an adjustment is then possible to reduce the number of browser engines assigned to data processing A, and increase the number of browser engines assigned to data processing B.

Thus, the wrapping engine apparatus of this embodiment which emulates the existing system on the browser upon request from a client's system may have the following functions, for example: The browser engines may be pooled in advance with the respective optimal screens corresponding to requests, by the browser engine pool and the browser engine pool managing section having two or more of browser engines and managing the statuses thereof. Upon receipt of a request, a browser engine having an optimal screen is extracted from among the pooled browser engines. Then, the request executing section executes on the extracted browser engine the script for calling for the function of the existing system.

According to the present invention, an execution instructing section is put on a state where a standby operation has been executed. This may allow an efficient execution instruction given to a data processing device in response to a request received from a client device.

### Embodiment 2

FIG. 9 shows a system configuration example of a wrapping system according to a second embodiment.

The wrapping system of FIG. 9 modifies the wrapping system of FIG. 1 that emulates an existing system by replacing the script/standby screen correspondence information 111 with the script/standby screen correspondence information 111b.

The standby screen managing section 106 and the browser engine managing section 107 of FIG. 1 are also replaced with the standby screen managing section 106a and the browser engine managing section 107a, respectively, to comply with the script/standby screen correspondence information 111b of this embodiment.

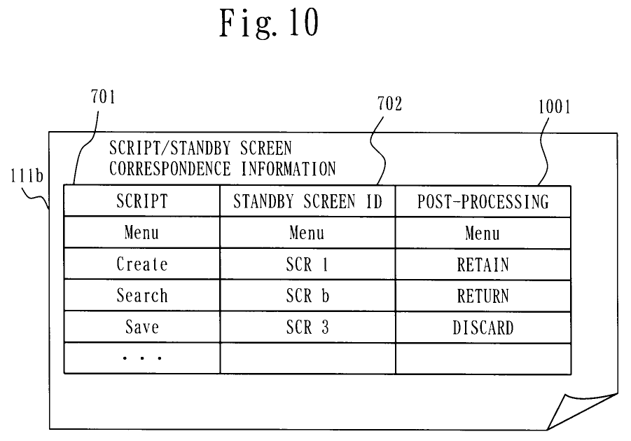

FIG. 10 shows the script/standby screen correspondence information 111b as an example of the script/standby screen correspondence information 111.

The script/standby screen correspondence information 111b of FIG. 10 modifies the script/standby screen correspondence information 111a of FIG. 7 by adding an information item of post-processing 1001 (post-processing information).

The post-processing 1001 specifies the post-processing of a browser engine after a script was executed. The post-processing may include: retaining the current state with no screen transition involved, discarding the current browser engine, and resetting the current standby screen.

When “Retain” is specified, the current screen can be used continuously. When “Return” is specified, a browser engine may be reused by bringing the current screen back to a standby screen, for repeating the same processing.

When a browser engine is not needed, “Discard” may be specified. It is also possible to reuse the browser engine by specifying a standby screen.

Note that the information memory section 124 of this embodiment is also an example of post-processing information memory section as well.

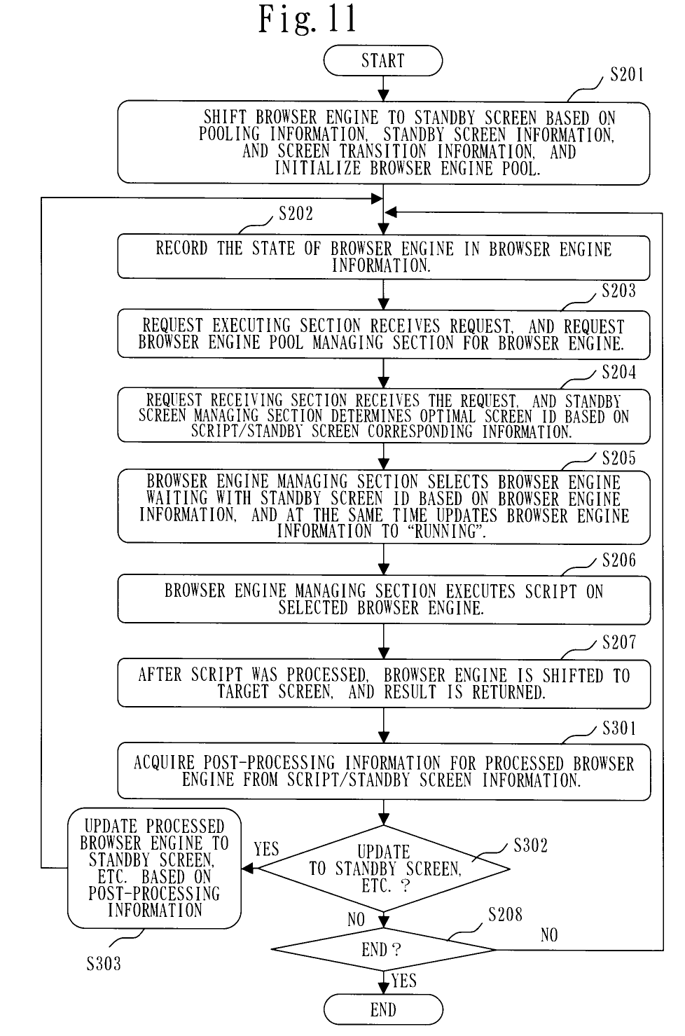

An operation of the wrapping engine apparatus 101 of this embodiment is now discussed with reference to FIG. 11.

FIG. 11 shows a flow chart illustrating an operation example of the wrapping engine apparatus 101. The flow chart of FIG. 11 modifies the flow chart of FIG. 2 for providing the optimal browser engine, by adding the post-processing of a browser engine for an efficient reuse of the browser engine.

An execution of the processes of Step S201 to Step S207 of FIG. 11 may allow the integrated system 131 to execute the function of the existing system 141 on an optimal browser engine.

After executing the function, the browser engine managing section 107 acquires the post-processing 1001 from the script/standby screen correspondence information (Step S301).

Next, the browser engine managing section 107 then determines whether to update the standby screen, or confirm end processing without performing any processing, according to the value of the post-processing 1001 (Step S302).

With the script of “Create” of the script/standby screen correspondence information 111b, for example, because “Retain” is given as the post-processing 1001, no update is to be made, and therefore the process proceeds to Step S208 to confirm the end processing (Step S208).

With the script of “Search”, because “Return” is given as the post-processing 1001, the process proceeds to Step S303 to update the standby screen, and return the screen back by an operation equal to clicking a return button (Step S303).

With the script of “Menu”, because “Menu” is given as the post-processing 1001, the process proceeds to Step S303 to update the standby screen, and shift the screen to “Menu” (Step S303).

With the script of “Save”, because “Discard” is given as the post-processing 1001, the process proceeds to Step S303 to update the standby screen, and discard the browser engine (Step S303).

In the case of updating the standby screen at Step S303, the process proceeds to Step S202 to update the browser engine information 112, and then to receive a request from the integrated system 131. The process is then repeated.

As aforementioned, according to this embodiment, the specification of the post-processing of a browser engine supplied from the browser engine pool 113 may allow an efficient reuse of managed browser engines.

Thus, the wrapping engine apparatus of this embodiment may have the following functions, for example: The definition of the post-processing may be included in the script/standby screen correspondence information in advance. The post-processing is the processing made by the browser engine managing section after the execution of the script on a browser engine supplied. The definition of the post-processing indicates whether to discard the browser engine or to retain the browser engine. After executing the script, the state of the browser engine pool may be updated efficiently, based on the definition of the post-processing.

### Embodiment 3

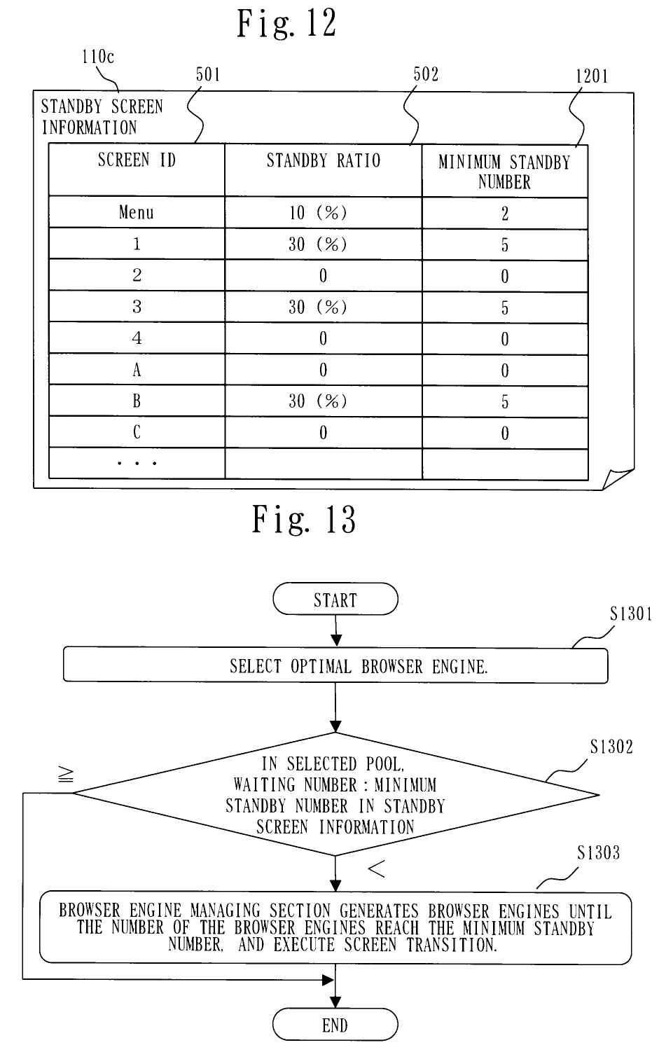

FIG. 12 shows standby screen information 110c that modifies the standby screen information 110a of FIG. 5 by adding an item of minimum standby number 1201 corresponding to the screen ID 501.

The minimum standby number 1201 indicates a minimum number of browser engines managed by the browser engine pool 113 to be put on standby on a screen ID basis.

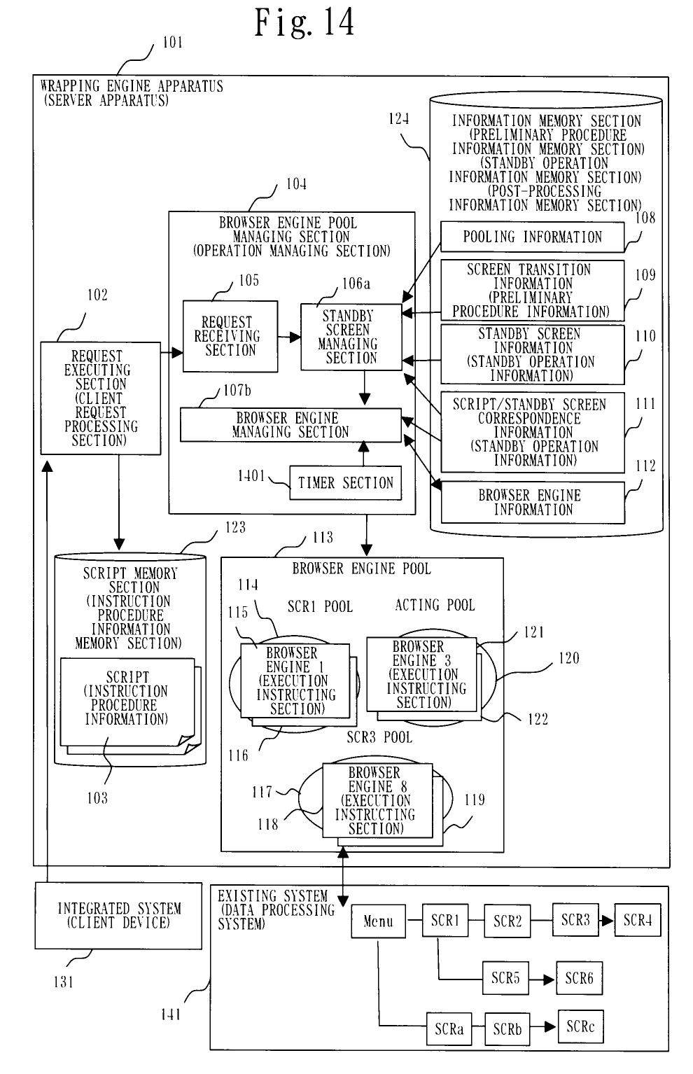

An operation of the wrapping engine apparatus of a third embodiment is now discussed with reference to FIG. 13.

FIG. 13 shows a flow chart illustrating an operation example of updating a standby screen by the browser engine managing section 107 in Step S205 in the flow chart of FIG. 2 or FIG. 11.

When the browser engine managing section 107 selects a browser engine having an optimal screen ID to a request (Step S1301), the browser engine information 112 is updated (the browser status 603 of a selected browser engine is changed from “Waiting” to “Running”).

Then, the browser engine managing section 107 compares the number of browser engines having the same screen ID as that of the selected browser engine, and having “Waiting” of the browser status 603, according to the browser engine information 112, with the minimum standby number 1201 defined in the standby screen information 110 (Step S1302).

When the number of browser engines having “Waiting” of the browser status 603 is smaller than the minimum standby number 1201, the browser engine managing section 107 generates browser engines until the number of browser engines reach the minimum standby number within the range of the set value of the maximum number of browser engines 404 of the pooling information 108a. Then a generated browser engine is shifted to a standby screen (Step S1303).

When the number of the browser engines having “Waiting” of the browser status 603 is not smaller than the minimum standby number 1201, then the process ends without performing processing.

As aforementioned, according to this embodiment, after the browser engine pool managing section 104 selects a browser engine, the browser engine pool 113 may be optimized on a screen ID basis. This may allow the entire number of browser engines to be optimized.

Thus, the wrapping engine apparatus of this embodiment may have the following functions, for example: The browser engine managing section, when selecting a browser engine to execute a script, examines the number of browser engines waiting in the pool where a supplied browser engine belongs. When the number of the browser engines waiting is smaller than the specified minimum standby number, then the standby screen managing section updates the standby state.

### Embodiment 4

FIG. 14 shows a wrapping engine apparatus that modifies the wrapping engine apparatus of FIG. 9 by adding a timer section 1401.

The wrapping engine apparatus according to a fourth embodiment of FIG. 14 may use a browser engine managing section 107b replaced for the browser engine managing section 107a of FIG. 9.

The browser engine apparatus 107b may include a function to perform update checking of the state of a browser engine regularly based on the timing of the timer section 1401.

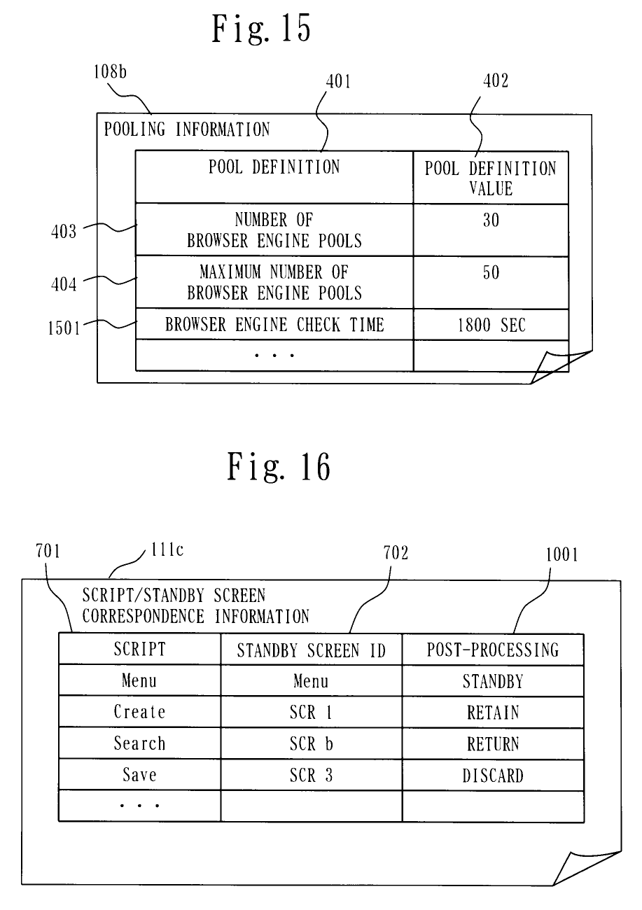

FIG. 15 shows pooling information 108b that modifies the pooling information of FIG. 4 by adding an item of browser engine check time 1501.

The browser engine check time 1501 indicates a time of checking for periodic optimization of the state of the browser engine pool 113 performed by the browser engine pool managing section 104.

FIG. 16 shows script/standby screen correspondence information 111c.

The post-processing 1001 of the script/standby screen correspondence information 111c of FIG. 16 shows a new item “Standby” in addition to “Retain”, “Return”, and “Discard”.

With “Standby”, a browser engine may be reused for another type of data processing after instructing the existing system 141 to execute some data processing.

However, no screen ID is set for putting the browser engine on standby, and therefore the browser engine stays on standby without a screen ID. Then, when entire browser engines are optimized, the browser engine is set on standby with a resultant screen ID from the optimization.

According to this embodiment, after a browser engine instructs the existing system 141 to execute data processing requested from the integrated system 131, the assignment of the browser engine is cancelled, and the browser engine is not assigned to any data processing and put on “Standby”. Therefore, the browser engine managing section 107b periodically extracts a browser engine whose assignment has been cancelled and which has not yet been assigned to any data processing, based on the timing of the timer section 1401. Then, the browser engine managing section 107b assigns an extracted browser engine to some data processing.

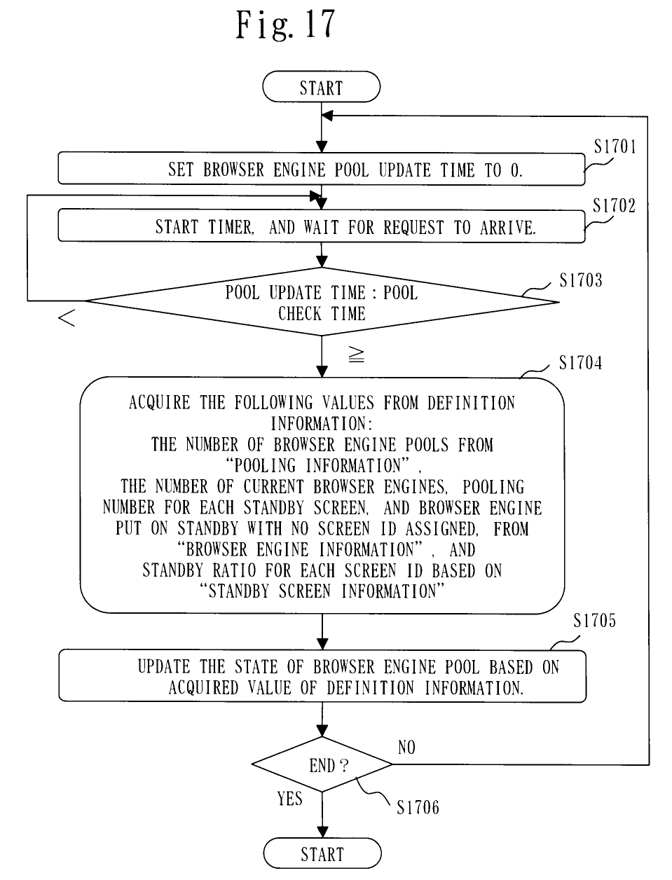

An operation of the wrapping engine apparatus 101 of this embodiment is now discussed with reference to FIG. 17.

FIG. 17 shows a flow chart illustrating an operation example for periodically updating browser engine pools by the browser engine pool managing section 104.

Note that the flow operation of FIG. 17 is performed in a separate routine from the flow operation of FIG. 2 or FIG. 11.

The browser engine managing section 107 sets a pool update time to 0 by using the timer section 1401 when starting the managing operation (Step S1701), and waits for a request to arrive while timer is running (Step S1702).

Next, the browser engine managing section 107 compares between the pool update time and the browser engine check time 1501 (Step S1703).

When the pool update time is within the browser engine check time 1501, then the process goes back to Step S1702.

When the pool update time goes over the browser engine check time 1501, then the browser engine managing section 107 acquires the “number of browser engine pools” from the pooling information 108b; acquires the current “number of browser engines”, the current “pooling number for each standby screen”, and the current “browser engines on standby having no screen ID specified” from the browser engine information 112; and acquires the “standby ratio for each screen ID” from the standby screen information 110 (Step S1704).

Then, the browser engine managing section 107 updates the state of the browser engine pool 113 based on the acquired values (Step S1705).

Even for a browser engine having no screen ID specified, a screen ID which contributes to entire optimization is set. The browser engine is put on standby with the set screen ID.

More specifically, the browser engine managing section 107 selects a screen ID which a relatively small number of browser engines are assigned to, and assigns a new screen ID (a selected screen ID) to a browser engine with no screen ID assigned.

As aforementioned, the browser engine pool managing section 104 may examine the definition information on a regular basis and update the state of the browser engine pool 113. This may allow the entire browser engines to be optimized.

Thus, the wrapping engine apparatus of this embodiment may have the following functions, for example: The browser engine managing section supplies a browser engine executing a script, and at the same time examines the standby state of the browser engine pool on a regular basis. This may update the standby state of the browser engine based on the standby screen information.

Lastly, a description is given of a hardware configuration example of the wrapping engine apparatus 101 described in the first embodiment to the fourth embodiment.

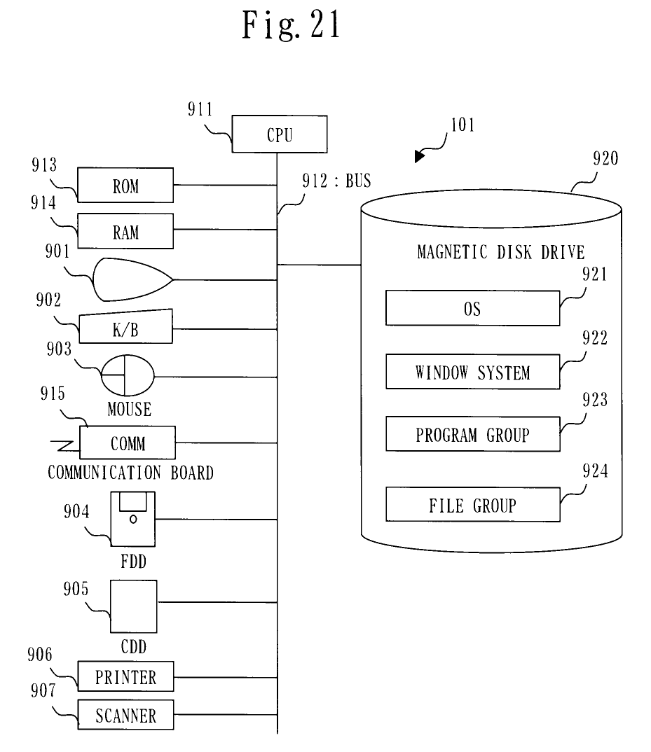

FIG. 21 shows a hardware resource example of the wrapping engine apparatus 101 described in the first embodiment to the fourth embodiment.

It is to be noted that the configuration of FIG. 21 is only an example of the hardware configuration of the wrapping engine apparatus 101. The hardware configuration of the wrapping engine apparatus 101 is not limited to the configuration of FIG. 21, and may be of another configuration.

Referring to FIG. 21, the wrapping engine apparatus 101 may include a CPU 911 for executing a program (which is also called a central processing unit, a processing unit, an arithmetic unit, a microprocessor, a microcomputer, or a processor).

The CPU 911 may be connected via a bus 912 to a Read Only Memory (ROM) 913, a Random Access Memory (RAM) 914, a communication board 915, a display unit 901, a keyboard 902, a mouse 903, and a magnetic disk drive 920, for example, and control these hardware devices.

The CPU 911 may further be connected to a Flexible Disk Drive (FDD) 904, a Compact Disk Drive (CDD) 905, a printer unit 906, and a scanner unit 907, for example. The magnetic disk drive 920 may be replaced by a storage device such as an optical disk drive or a memory card (Registered Trademark) read/write unit.

The RAM 914 is an example of a volatile memory. The storage media of the ROM 913, the FDD 904, the CDD 905, and the magnetic disk drive 920 are examples of nonvolatile memories. These are examples of storage devices.

The communication board 915, the keyboard 902, the mouse 903, the scanner unit 907, the FDD 904 are examples of input devices.

The communication board 915, the display unit 901, and the printer unit 906 are examples of output devices.

The communication board 915 may be connected to the integrated system 131 and the existing system 141 over a network. The communication board 915 may be connected to a Local Area Network (LAN), the Internet, a Wide Area Network (WAN), or the like, for example.

The magnetic disk drive 920 may store an Operating System (OS) 921, a window system 922, a program group 923, and a file group 924.

The programs of the program group 923 may be executed by the CPU 911 using the operating system 921 and the window system 922.

The RAM 914 may temporarily store at least part of the program of the operating system 921 to be executed by the CPU 911 and an application program.

The RAM 914 may also store a variety of data necessary for CPU 911 processing.

The ROM 913 may store a Basic Input Output System (BIOS) program. The magnetic disk drive 920 may store a boot program.

When the wrapping engine apparatus 101 is started, the BIOS program of the ROM 913 and the boot program of the magnetic disk drive 920 may be executed. The BIOS program and the boot program may start the operating system 921.

The program group 923 may include programs for executing functions described as “sections” in the descriptions of the first embodiment to the fourth embodiment. The programs may be read by the CPU 911 to be executed.

The browser engines may be included in the program group 923.

The process of a browser engine on standby may be loaded into the RAM 914, and is in a waiting state to be executed by the CPU 911.

The script memory section 123 and the information memory section 124 may be implemented by the magnetic disk drive 920, for example. The script 103, the pooling information 108, the screen transition information 109, the standby screen information 110, the script/standby screen correspondence information 111, and the browser engine information 112 may be included in the file group 924, for example.

In the file group 924, information, data, signal values, variable values and parameters indicating processing results described as “identification”, “acquisition”, “comparison”, determination”, “updating”, “setup”, “execution”, “selection”, etc. in the descriptions of the first embodiment through the fourth embodiments, may be stored as “file” items or “database” items.

The “files” and “databases” may be stored in a storage medium such as a disk or a memory. Information, data, signal values, variable values and parameters stored in a storage medium such as a disk or a memory may be read out to a main memory or a cash memory by the CPU 911 via a read/write circuit, and used for an CPU operation, such as for extracting, retrieving, referring, comparing, operating, calculating, processing, editing, outputting, printing, displaying, or the like.

During a CPU operation for extracting, retrieving, referring, comparing, operating, calculating, processing, editing, outputting, printing, or displaying, information, data, signal values, variable values or parameters may be temporarily stored in a main memory, a register, a cash memory, a buffer memory, or the like.

Arrows shown in the flow charts referred to in the first embodiment to the fourth embodiment indicate mainly the input/output of data or a signal. Data and signal values may be stored in the memory of the RAM 914, the flexible disk of the FDD 904, the compact disk of the CDD 905, the magnetic disk of the magnetic disk drive 920, or other storage medium such as an optical disk, a mini disk, a DVD, and the like. Data and signals may be transmitted online by way of the bus 912, a signal line, a cable, or other transmission media.

What is described as a “section” in the descriptions of the first embodiment to the fourth embodiment may be a “circuit”, a “device”, or “equipment”, or may even be a “step”, a “procedure”, or a “process”. In other words, what is described as a “section” may be implemented by firmware stored in the ROM 913. Alternatively, what is described as a “section” may also be implemented by software only, a combination of software and hardware, or a combination of software, hardware and firmware. Firmware and software may be stored as a program in a storage medium such as a magnetic disk, a flexible disk, an optical disk, a compact disk, a mini disk, a DVD, or the like. A program is read and executed by the CPU 911. More particularly, a program makes a computer work as a “section” described in the first embodiment to the fourth embodiment, or makes a computer execute a procedure or method of a “section” described in the first embodiment to the fourth embodiment.

Thus, the wrapping engine apparatus 101 described in the first embodiment to the fourth embodiment may be a computer including a processor such as a CPU, a storage device such as a memory, a magnetic disk, or the like, an input device such as a keyboard, a mouse, a communication board, or the like, and an output device such as a display device, a communication board, or the like. As described earlier, the wrapping engine apparatus 101 may implement the function described as the “section” by using the processing device, the storage device, the input device, and the output device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A server apparatus that is connected to a data processing system performing data processing, the server apparatus comprising:
an execution instructing section that instructs the data processing system to perform the data processing;
a standby operation information memory section that stores standby operation information indicating a specific operation, as a standby operation, among a set of operations needed for the execution instructing section instructing the data processing system to perform the data processing;
a preliminary procedure information memory section that stores preliminary procedure information indicating an operating procedure until the standby operation; and
an operation managing section that sets the execution instructing section to a state where the standby operation has been executed, based on the standby operation information and the preliminary procedure information, and puts the execution instructing section on standby in the state where the standby operation has been executed.

2. The server apparatus according to claim 1, wherein the server apparatus is connected to a client device requesting the data processing in the data processing system,
the server apparatus further comprising:
a client request processing section that receives a request for the data processing from the client device; and
an instruction procedure information memory section that stores instruction procedure information indicating an operating procedure subsequent to the standby operation,
wherein the operation managing section makes the execution instructing section on standby execute an operation subsequent to the standby operation, based on the instruction procedure information, and instruct the data processing system to execute the data processing, when the client request processing section receives the request at the client device.

3. The server apparatus according to claim 1, wherein the server apparatus is connected to a data processing system performing a plurality of types of data processing,
the server apparatus further comprising:
a plurality of execution instructing sections,
wherein the standby operation information memory section stores a standby operation information indicating a standby operation for each data processing among the plurality of types of data processing,
wherein the preliminary procedure information memory section stores the preliminary procedure information for each data processing, and
wherein the operation managing section assigns at least one of the plurality of execution instructing sections for each data processing in association with the standby operation, based on the standby operation information, sets each assigned execution instructing section to the state where the standby operation has been executed, based on the preliminary procedure information for each data processing, and puts the assigned execution instructing section on standby in the state where the standby operation has been executed.

4. The server apparatus according to claim 3, wherein the server apparatus is connected to a client device requesting data processing in the data processing system;
the server apparatus further comprising:
a client request processing section that receives a request for the type of data processing from the client device, and identifies requested data processing from the client device among the plurality of types of data processing; and
an instruction procedure information memory section that stores instruction procedure information indicating an operating procedure subsequent to the standby operation of each data processing,
wherein the operation managing section selects an assigned execution instructing section on standby that is assigned to the requested data processing identified by the client request processing section, makes the assigned execution instructing section selected execute an operation subsequent to the standby operation, based on the instruction procedure information of the requested data processing, and instruct the data processing system to execute the requested data processing, when the request from the client device is received at the client request processing section.

5. The server apparatus according to claim 3, wherein the standby operation information memory section stores standby operation information indicating the standby operation of each data processing and the number of execution instructing sections to be assigned to each data processing;
wherein the operation managing section assigns the execution instructing section of the number indicated by the standby operation information to each data processing.

6. The server apparatus according to claim 3, further comprising:
post-processing information memory section that stores post-processing information specifying, for each data processing, a state of the assigned execution instructing section after the assigned execution instructing section instructs the data processing system to execute the requested data processing,
wherein the operation managing section sets an assigned execution instructing section to the state specified by the post-processing information, after the assigned execution instructing section instructs the data processing system to execute the requested data processing.

7. The server apparatus according to claim 6, wherein the post-processing information memory section stores post-processing information specifying that the assigned execution instructing section is returned to the state where the standby operation has been executed, after the assigned execution instructing section instructs the data processing system to execute the requested data processing.

8. The server apparatus according to claim 3, wherein the standby operation information memory section stores standby operation information indicating the standby operation of each data processing and a minimum standby number of the assigned execution instructing section to be assigned to each data processing, and
wherein the operation managing section, for each data processing, counts the number of the assigned execution instructing section on standby, compares a counted number of the assigned execution instructing section on standby with the minimum standby number indicated by the standby operation information, and assigns a new execution instructing section to the data processing so as to have the assigned execution instructing section on standby of at least the minimum standby number, when the counted number of the assigned execution instructing section on standby is smaller than the minimum standby number.

9. The server apparatus according to claim 3, wherein the operation managing section cancels the assignment of an assigned execution instructing section after the assigned execution instructing sections instructs the data processing system to execute the requested data processing, and
wherein the operation managing section periodically extracts an execution instructing section whose assignment has been cancelled and which has not yet been assigned to any data processing, and assigns an extracted execution instructing section to some data processing.

10. The server apparatus according to claim 1, wherein the standby operation information memory section stores standby operation information indicating an acquisition operation of specific screen information as the standby operation, and
wherein the operation managing section sets the execution instructing section to a state where the acquisition operation of the specific screen information has been executed, based on the standby operation information and the preliminary procedure information, and puts the execution instructing section on standby in the state where the acquisition operation of the specific screen information has been executed.

11. The server apparatus according to claim 1, wherein the server apparatus is connected to the data processing system as a legacy system, and
wherein the server apparatus is a legacy wrapping apparatus that emulates a terminal device corresponding to the data processing system, and instructs the data processing system to execute the data processing.

12. A computer readable recording medium encoded with computer program instructions, which when executed by a computer having a storage device and an execution instructing section that instructs a data processing system for performing data processing to execute the data processing, cause the computer to carry out a method of managing the execution instructing section, comprising:
acquiring, from the storage device, standby operation information indicating a specific operation, as a standby operation, among a set of operations needed for the execution instructing section instructing the data processing system to execute the data processing,
acquiring, from the storage device, preliminary procedure information indicating an operating procedure until the standby operation,
setting the execution instructing section to a state where the standby operation has been executed, based on the standby operation information and the preliminary procedure information so that the execution instructing section is set, and
putting the execution instructing section on standby in the state where the standby operation has been executed.
